(19) United States
(12) Patent Application Publication
(10) Pub. No.: US 2009/0013864 A1
(43) Pub. Date: Jan. 15, 2009

(54) Connecting Plate of a Hydrostatic Machine and Method for Producing the Connecting Plate

(75) Inventors: Gordon Mohn, Horb (DE); Martin Zug, Hirrlingen (DE)

Correspondence Address: SCULLY SCOTT MURPHY & PRESSER, PC, 400 GARDEN CITY PLAZA, SUITE 300, GARDEN CITY, NY, 11530, US

(73) Assignee: BRUENINGHAUS HYDROMATIC GMBH, ELCHINGEN (DE)

(21) Appl. No.: 10/577,001

(22) PCT Filed: Oct. 11, 2004
(86) PCT No.: PCT/EP04/11350

§ 371 Date: Apr. 24, 2006

(30) Foreign Application Priority Data
Oct. 23, 2003 (DE) 103 49 318.2

(51) Int. Cl. F01B 3/02; B23P 15/00

(52) U.S. Cl. 92/71; 29/888.02

(57) ABSTRACT

The invention relates to a connecting plate and to a method for producing connecting plates of hydrostatic machines. The connecting plate is cut to length from a previously produced extruded profile to give connecting plate blanks and is then finished.

The invention relates to a method for producing a connecting plate in addition to the connecting plate of a hydrostatic machine, in particular an axial piston machine.

In DE 199 14 268 A1, for example, a connecting plate is used in an axial piston machine of inclined axis construction. The connecting plate closes an elliptical housing portion. A control body formed as a biconvex oval control portion is displaceably arranged in a circular support- and pivot bearing in the connecting plate. The control body has apertures for passing through hydraulic medium.

An axial piston machine of swash plate construction is further known from DE 44 23 023 A1 with adjustable displacement volume. The machine disclosed herein also uses a connecting plate which, in this case, is referred to as a connecting block.

Such aforementioned connecting plates are conventionally made from individually cast or forged plate-shaped blanks.

A disadvantage therewith is the relatively cost-intensive production of such plate-shaped semi-finished products with many energy-intensive processing steps. The production effort, production cost and the time required to produce the connecting plate is thereby markedly increased. In particular, the thickness of the connecting plate can only be altered by a method requiring high production effort, for example by a new casting mould or a new die.

The object of the invention is to provide a simple, flexible and cost-effective production method for a connecting plate of a hydrostatic machine which reduces the production effort of such a connecting plate and reduces the number of processing steps and to disclose a connecting plate which can be made cost-effectively and with little production effort.

The object is achieved with regard to the method according to the invention by the features of claim 1 and with regard to the subject of the connecting plate by the features of claim 9.

With the production method according to the invention for producing a connecting plate, the connecting plate blank resulting from an intermediate step in the production of the connecting plate, is cut to length from an extruded profile and not individually cast or forged, as in conventional production methods.

The measures stated in the sub-claims refer to advantageous developments of the production method according to the invention and of the connecting plate according to the invention.

It is particularly advantageous to produce the extruded profile by continuous casting or extruding. As a result, the extruded profile can be particularly easily and cost-effectively produced.

It is further advantageous if the extruded profile consists at least partially of aluminium, copper or iron or from an alloy with at least one of these metals. As a result, the connecting plate can be easily produced with the desired material properties.

It is further advantageous if the extruded profile is congruent in cross-section with the contour of the finished connecting plate. The contour of the connecting plate-blank cut to length from the extruded profile therefore no longer has to be reworked.

It is also advantageous if the extruded profile is cut to length into at least two connecting plate-blanks. As a result, the production method is markedly simpler as a plurality of connecting plate-blanks can be produced in a simple manner from one extruded profile.

A preferred embodiment of the connecting plate according to the invention is shown in the drawings and is described in more detail in the following description, in which:

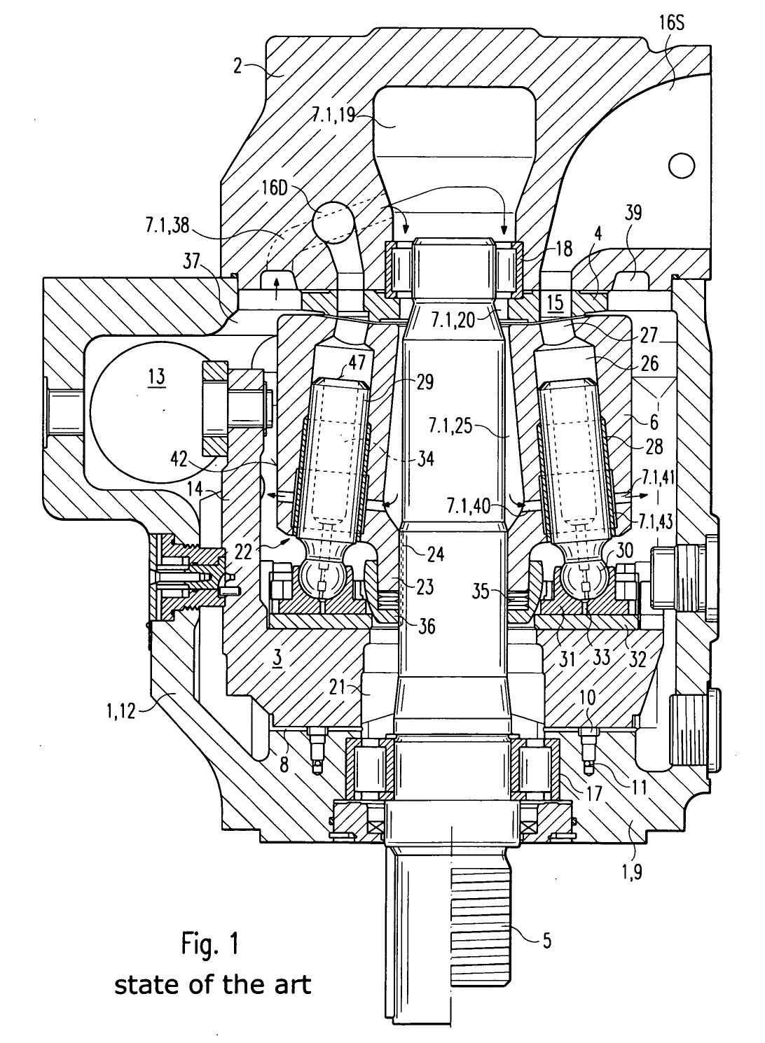

FIG. 1 is a hydrostatic machine shown diagrammatically with a connecting plate according to the prior art,

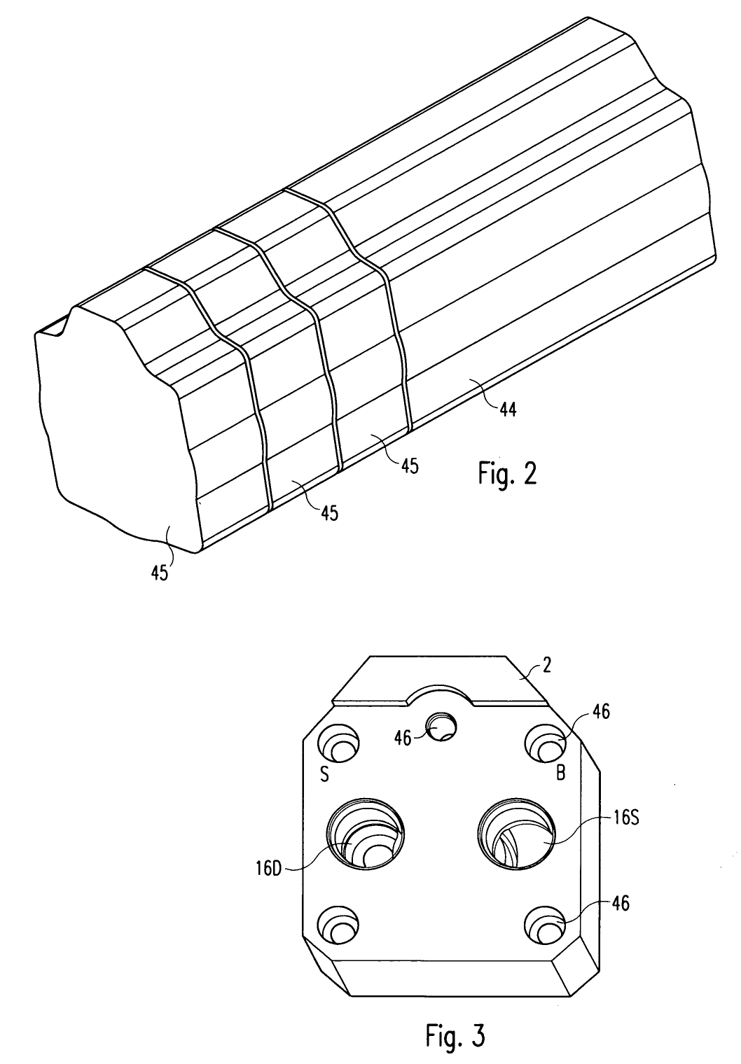

FIG. 2 is an extruded profile with three connecting plate-blanks cut to length to describe the production method according to the invention and

FIG. 3 is an embodiment of a connecting plate according to the invention.

Before the connecting plate according to the invention and the method for producing the connecting plate according to the invention is disclosed with reference to FIG. 2 and 3, a hydrostatic machine with a connecting plate according to the prior art is described with reference to FIG. 1 for better understanding of the invention.

The axial piston machine shown in FIG. 1 is of swash plate construction with adjustable displacement volume and one flow direction and comprises in the known manner as main components a hollow cylindrical housing 1 with one end (the upper end in FIG. 1) open at the end face, a connecting plate 2 attached to the housing 1 and closing the open end of said housing, a stroke disc or swash plate 3, a control body 4, a drive shaft 5, a cylinder drum 6 and, in the embodiment shown, an optional cooling circuit 7.1.

The swash plate 3 is configured as a so-called tilting rocker with a semi-cylindrical cross-section and is supported by two bearing surfaces, extending with mutual spacing parallel to the tilt direction, with hydrostatic relief, on two correspondingly formed bearing shells 8 which are attached to the inner surface of the housing end wall 9 opposing the connecting plate 2. The hydrostatic relief is carried out in the known manner via pressure pockets 10 which are configured in the bearing shells 8 and supplied with pressure medium via connections 11. A setting device 13 accommodated in a bulge of a cylindrical housing wall 12 engages the swash plate 3 by means of an arm 14 extending in the direction of the connecting plate 2 and serves to tilt said swash plate about a tilt axis perpendicular to the tilt direction.

The control body 4 is attached to the inner surface of the connecting plate 2 facing the housing interior and is provided with two through-holes 15 in the form of kidney-shaped control slots which are connected via a pressure channel 16D and/or suction channel 16S in the connecting plate 2 to a pressure- and suction line, not shown. The pressure channel 16D has a smaller flow cross-section than the suction channel 16S. The spherically formed control surface of the control body 4 facing the housing interior serves as a bearing surface for the cylinder drum 6.

The drive shaft 5 penetrates the housing 1 through a through-bore in the housing end wall 9 and is rotatably mounted by means of a bearing 17 in this through-bore and by means of a further bearing 18 in a narrower bore section of a blind bore 19, widened at one end, in the connecting plate 2 and in a region, adjacent to this narrower bore section, of a central through-bore 20 in the control body 4. The drive shaft 5 moreover penetrates a central through-bore 21 in the swash plate 3 in the interior of the housing 1 and of which the diameter corresponds to the largest tilt movement of the swash plate 3, and a central through-bore in the cylinder drum 6 with two bore sections.

One of these bore sections is configured in a sleeve-shaped extension 23 formed on the cylinder drum 6, projecting beyond the end face 22 thereof facing the swash plate 3 and via which the cylinder drum 6 is rotationally fixedly connected to the drive shaft 5 by means of a splined-connection 24. The remaining bore section is configured with a conical extension. It tapers from its cross-section of largest diameter in the vicinity of the first bore section as far as its cross-section of smallest diameter in the vicinity of the end- or bearing surface of the cylinder drum 6 abutting the control body 4. The annular chamber defined by the drive shaft 5 and this conical bore section is designated by the reference numeral 25.

The cylinder drum 6 generally comprises axially extending, stepped cylinder bores 26 which are arranged evenly on a pitch circle coaxial to the drive shaft axis. The cylinder bores 26 open out directly at the cylinder drum-end face 22 and at the cylinder drum-bearing surface facing the control body 4, via opening channels 27 on the same pitch circle as the control slots. One respective bush 28 is inserted into the cylinder bore sections of larger diameter, opening out directly at the cylinder drum-end face 22. The cylinder bores 26, together with the bushes 28, are referred to here as cylinders. Pistons 29 arranged displaceably within these cylinders are provided at their ends facing the swash plate 3 with ball heads 30 which are mounted in slippers 31 and via said slippers are hydrostatically mounted on an annular slide disc 32 attached to the swash plate 3. Each slipper 31 is provided at its slide surface facing the slide disc 32 with one respective pressure pocket, not shown, which is connected via a through-bore 33 in the slipper 31 to a stepped axial through-channel 34 in the piston 29 and in this manner is connected to the working chamber of the cylinder defined by the piston 29 in the cylinder bore 26. A choke is configured in each axial through-channel 34 in the region of the associated ball head 30. A hold-down device 36 arranged axially displaceably on the drive shaft 5 by means of the splined-connection 24 and acted upon by a spring 35 in the direction of the swash plate 3 holds the slippers 31 in abutment on the slide disc 32.

The space not taken up in the housing interior by the components 3 to 6, etc. accommodated therein, serves as a leakage chamber 37 which, during operation of the axial piston machine, receives leakage fluid emerging through all gaps, such as for example between the cylinders and the pistons 29, the control body 4 and the cylinder drum 6, the swash plate 3 and the slide disc 32, in addition to the bearing shells 8, etc.

The function of the axial piston machine described above is generally known and in the following description, relating to its use as a pump, is restricted to that which is significant.

The axial piston machine is provided with oil as fluid for its operation. The cylinder drum 6 together with the pistons 29 are set into rotation via the drive shaft 5. When, by actuating the setting device 13, the swash plate 3 is tilted into an oblique position relative to the cylinder drum 6, all pistons 29 perform stroke movements. When rotating the cylinder drum 6 by 360° each piston 29 carries out a suction- and a compression stroke, corresponding oil flow being produced, the supply and discharge of which taking place via the opening channels 27, the control slots 15 and the pressure- and suction channels 16D, 16S. In this connection, during the compression stroke of each piston 29, hydraulic oil flows from the relevant cylinder via the axial through-channel 34 and the through-bore 33 in the associated slipper 31 into the pressure pocket thereof and creates a pressure field between the slide disc 32 and the respective slipper 31 which serves as hydrostatic bearing thereof. Furthermore, hydraulic oil is supplied via the connections 11 to the pressure pockets 10 in the bearing shells 8 for the hydrostatic support of the swash plate 3.

The cooling circuit 7.1 present in the embodiment shown but not in any way necessary within the scope of the present invention, is connected to the leakage chamber 37 and comprises the conical annular chamber 25 (so-called leakage fluid receiving chamber), the through-bore 20 in the control body 4, the blind bore 19 (so-called further leakage fluid receiving chamber), a connection line 38 connecting said chamber to the leakage chamber 37, which opens out in a circumferential groove 39 in the inner surface of the connecting plate 2, and corresponding cooling regions surrounding the cylinders 26, 28, which are connected to the conical annular chamber 25 via supply channels 40 and open out into the leakage chamber 37 via discharge channels 41 at the cylindrical boundary surface 42 of the cylinder drum 6. All supply channels 40 open into the conical annular chamber 25 at its cross-section of largest diameter and also extend, as with all the discharge channels 41, substantially radially through the cylinder drum 6.

In the configuration according to FIG. 1 a cooling region in the form of an annular chamber 43 is associated with each cylinder and which is configured as a circumferential groove in the wall of the cylinder bore section of larger diameter and is covered by the bush 28. The annular chamber 43 extends from the vicinity of the opening region of the cylinder bore 26 over approximately two thirds of the length thereof in the direction of the opening channels 27 and thus represents an upper cooling region associated with the upper dead centre position of the piston 29. A supply channel 40 and a discharge channel 41 both open approximately centrally into the annular chamber 43 and extend coaxially to one another.

A conventional axial piston machine having been disclosed above, the particularities according to the invention are now dealt with in greater detail.

FIG. 2 shows an extruded profile 44 from which the first three connecting plate-blanks 45 are cut to length in a method step according to the invention. The extruded profile consistently has the same cross-section along its longitudinal axis and is shaped according to the desired contour of the finished connecting plate 2. As a result, subsequent processing steps for shaping the contour of the connecting plate 2, which are costly, are not required. The extruded profile 44 is cut to length into a plurality of connecting plate-blanks 45 of the same or various sizes and/or thicknesses. As a result, connecting plate-blanks 45 for the production of connecting plates 2 for various designs of hydrostatic machines, in particular for pumps of varying performance, can be very easily produced.

The connecting plate-blanks 45 are, for example, cut off by saws or water jet cutting from the extruded profile 44. Depending on the material of the extruded profile 44, the required accuracy and the desired number of connecting plates 2, other cutting methods can be used, for example laser cutting or burning out methods. In the production step shown in FIG. 2, the connecting plate-blanks 45 are cut off at right angles to the longitudinal axis of the extruded profile 44, so that the two surfaces located at right angles to the longitudinal axis of the connecting plate-blanks 45 extend parallel. For example, the connecting plate-blanks 45 can also be cut off and/or cut to length from the extruded profile 44 by an oblique cut, whereby the connecting plate-blank 45 and/or the connecting plate 2 are wedge-shaped and/or concave. The extruded profile 44 preferably consists at least partially of aluminium, iron or copper or a corresponding alloy.

Depending on the required number of connecting plates 2 and the desired material properties, the extruded profile 44 is produced, for example, by continuous casting or extruding. The extruded profile 44 is as a result, for example, designed and/or produced as a continuous cast profile 44 or an extruded profile 44.

FIG. 3 shows an embodiment of a connecting plate 2 according to the invention by way of example. In a method step according to the invention, the connecting plate 2 has been firstly cut to length from the extruded profile 44 by means of a cut on the extruded profile 44 extending at right angles to the longitudinal axis of the extruded profile 44. In a further method step according to the invention, the resulting connecting plate-blank 45 has been further processed. In the embodiment shown here, the pressure channel 16D, the suction channel 16S and a plurality of other apertures 46, which for example can be constituents of a screw connection, can be introduced by drilling into the connecting plate-blank 45. With further processing, for example, the connection line 38, the blind bore 19 and the groove 39 can be introduced into the connecting plate-blank 45.

The connecting plate 2 produced by the method according to the invention can be produced very inexpensively and rapidly, even in various sizes and/or thicknesses, resulting in considerable cost advantages with regard to the production method known from the prior art.

1. Method for producing connecting plates of hydrostatic machines with the following method steps
producing an extruded profile;
cutting the extruded profile to length into connecting plate-blanks;
further processing of the connecting plate-blanks cut to length wherein the extrude profile is cut to length into connecting plate-blanks of various thicknesses.

2. Method according to claim 1, wherein the extruded profile is produced by continuous casting or extruding.

3. Method according to claim 1, wherein the extruded profile (44) is produced at least partially from aluminium, iron or copper, or from an alloy with at least one of these metals.

4. Method according to claim 1, wherein the cutting to length takes place by sawing, laser cutting, water jet cutting or by a burning out method.

5. Method according to claim 1, wherein in cross-section, the contour of the extruded profile and the contour of the connecting plate are congruent.

6. Method according to claim 1, wherein the extruded profile is cut to length into at least two connecting plate-blanks.

7. Method according to claim 1, wherein during further processing of the connecting plate-blanks cut to length from the extruded profile, a pressure channel, a suction channel, a blind bore, a groove and/or a connection line are introduced into the connecting plate-blank (45).

8. Method according to claim 1, wherein during further processing of the connecting plate-blanks cut to length from the extruded profile the connecting plate-blank is deburred.

9. Connecting plate of a hydrostatic machine, the connecting plate being produced from an extruded profile, the connecting plate being made from a connecting plate-blank which is cut off from the extruded profile,
wherein in cross-section the contour of the extruded profile and the contour of the connecting plate are congruent and in that a blind bore and a groove and/or a connection line are introduced into the connecting plate-blanks which are cut to length.

10. Connecting plate according to claim 9,
wherein the connecting plate is produced from an extruded profile which is produced by continuous casting or extruding.

11. Connecting plate according to claim 9,
wherein the connecting plate is produced from an extruded profile which consists at least partially of aluminium, iron or copper or from an alloy with at least one of these metals.

12. Connecting plate according to claim 9,
wherein the connecting plate-blank from which the connecting plate is made, is cut off from the extruded profile by sawing, laser cutting, water jet cutting or by a burning out method.

13. Connecting plate according to any one of claims 9 to 12,
characterised in that
in cross-section the contour of the extruded profile and the contour of the connecting plate are congruent.
